(19) United States
(12) Patent Application Publication
(10) Pub. No.: US 2003/0168237 A1
(43) Pub. Date: Sep. 11, 2003

(54) Wall-mounted electric devices

(76) Inventor: Cesar Wengrower, Lanus Oeste (AR)

Correspondence Address: GOTTLIEB RACKMAN & REISMAN PC, 270 MADISON AVENUE, 8TH FLOOR, NEW YORK, NY, 100160601

(21) Appl. No.: 10/094,095

(22) Filed: Mar. 8, 2002

(51) Int. Cl. H02G 3/14

(52) U.S. Cl. 174/66

(57) ABSTRACT

A set of cover 2 and support 3 for electric devices 4 comprising an intermediate support 1—on which frame 40 of the electric device 4 is mounted—and an decorative outer cover 2 with an inner frame 3, both mountable on the previously mentioned intermediate support 1. The frame 40 of the electric device 4 is mounted on the intermediate support 1; the decorative inner frame 3 is engaged in the decorative outer cover 2. The set protects the electric device 4 and the assembly opening 5. The decorative outer cover 2 and the inner frame 3 can be independently exchanged to vary the external appearance of the set.

### I—BACKGROUND OF THE INVENTION

1. Technical Field

This invention relates to covers for the mounting of electric devices through openings. Specifically, this invention relates to a set of cover and support that, while being applicable to electric switches and power sockets, it allows a better protection of the electric parts as well as the modification of their ornamental aspect.

2. Description of Prior Art

Most of the conventional cover systems for electric devices, such as electric switches, power sockets or telephone connectors comprise an outer cover that is fixed to the frame of the device by means of screws.

In such conventional systems, when the outer cover breaks down, the frame of the device turns visible, thus affecting their aesthetic aspect and, what is more dangerous, leaving the electric parts exposed, with the resulting danger to the user.

Other cover systems are known in the prior art. For example, some types comprise a support and an outer cover. The support is fixed to the electric device frame by means of screws and the cover is mounted on the frame by means of screws or engagement systems.

The problem with these systems is that the support is too narrow and does not cover the whole assembly opening. In addition, to reduce material cost, the support is skeleton-like. Consequently, when the outer cover breaks down, the electric parts are left exposed with the resulting danger.

Furthermore, all these systems present the disadvantage of having limited decorative possibilities, since in order to change their appearance, the only possible thing is to change the outer cover.

### II—SUMMARY OF THE INVENTION

The present invention consists of a set of cover and support for electric devices, such as a switch or socket mounted on an assembly opening; comprising: an intermediate support, that extends over the assembly opening; such intermediate support—where the frame of such electric device is fixed—that has a central opening to mount such electric device and retentive engagement means in, at least, two of its opposite side edges; a decorative outer cover the central opening of which is bigger than the electric device and has retentive engagement means in two of its opposite side edges, in correspondence with such intermediate support; a removable decorative inner frame that, when mounted on such outer cover, surrounds such electric device; and retentive engagement means between such outer cover and such inner frame.

### OBJECTS AND ADVANTAGES

Some of the objects and advantages of this invention are described herein below:

a) It is an object of the exemplary form of the present invention to provide a very robust set that better resists knocks or impacts, thus reducing breakage.

b) It is a further object of the exemplary form of the present invention to provide a set that, in the event of breakage of the outer cover, it does not leave the electric parts exposed and avoids accidents to the user.

c) It is a further object of the exemplary form of the present invention to provide a set that limits the introduction of elements such as dust, water or moist into the assembly opening.

d) It is a further object of the exemplary form of the present invention to provide a set that enhances the decorative possibilities thereof, as different outer covers can be exchanged with different inner frames.

e) It is a further object of the exemplary form of the present invention to provide a set that eliminates the inconveniences of the assembly openings wherein the flanges are too deep, since the electric device frame is mounted on the intermediate support that immobilizes it.

f) It is a further object of the exemplary form of the present invention to provide a set that facilitates the painting of walls, since it is not necessary to dismount the whole set nor to remove the intermediate support, but only the outer cover.

g) It is an object of the exemplary form of the present invention to provide a set wherein its parts are fixed together by means of an engagement system, without screws.

h) It is an object of the exemplary form of the present invention to provide a set that can be applied to different electric devices such as electric switches, power sockets, telephone connectors, computer connectors, video connectors, etc.

### III—BRIEF DESCRIPTION OF DRAWINGS

For further clarity and understanding of the objects of the present invention, the invention is accompanied with several drawings showing some of its preferred embodiments; however the descriptions and illustrations herein are merely examples and the invention is not limited to the exact details shown and described.

FIG. 1 is an enlarged perspective view of the set of cover and support, according to one of the exemplary forms of the present invention.

FIG. 2 is a front view of the decorative outer cover and inner frame shown in FIG. 1, both assembled.

FIG. 3 is a front view of the intermediate support.

FIG. 4 is a rear view of the intermediate support.

FIG. 5 is a front view of the decorative outer cover.

FIG. 6 is a rear view of the decorative outer cover.

FIG. 7 is a front view of the decorative inner frame.

FIG. 8 is a rear view of the decorative inner frame.

FIG. 9 is a front view of the intermediate support in another exemplary embodiment, for two electric devices.

FIG. 10 is a front view of the outer cover applicable to an intermediate support, as the one shown in FIG. 9.

FIG. 11 is a front view of the inner frame applicable to an outer cover, as the one shown in FIG. 10.

In the different drawings, the same reference numerals indicate identical or the corresponding parts.

### REFERENCE NUMERALS IN DRAWINGS

1. Intermediate support

2. Decorative outer cover

3. Decorative inner frame

4. Electric device

5. Assembly opening

6. Hole for fixing onto the frame

7. Elastic engagement means

8. Openings with elastic backward motion

9. Central opening of intermediate support

10. Side cavities

11. Side projection

12. Dismount point

13. Structural reinforcement

14. Cavity

20. Decorative outer surface

21. Central opening of outer cover

22. Central opening edges

23. Inner cavity

24. Lateral engagement means

25. Retentive engagement means

26. Dismounting slot

30. Decorative outer surface

31. Central opening of inner frame

32. Side projections

33. Inner reinforcement

40. Frame

41. Mounting hole of intermediate support

60. Double frame

61. Openings

62. Intermediate partitioning element

70. Double decorative outer cover

71. Double central opening

72. Edges

73. Decorative outer surface

80. Double decorative inner frame

81. Central openings

82. Intermediate partitioning element

83. Passages

84. Head passages

85. Decorative outer surface

### IV—DETAILED DESCRIPTION

Preferred Embodiment

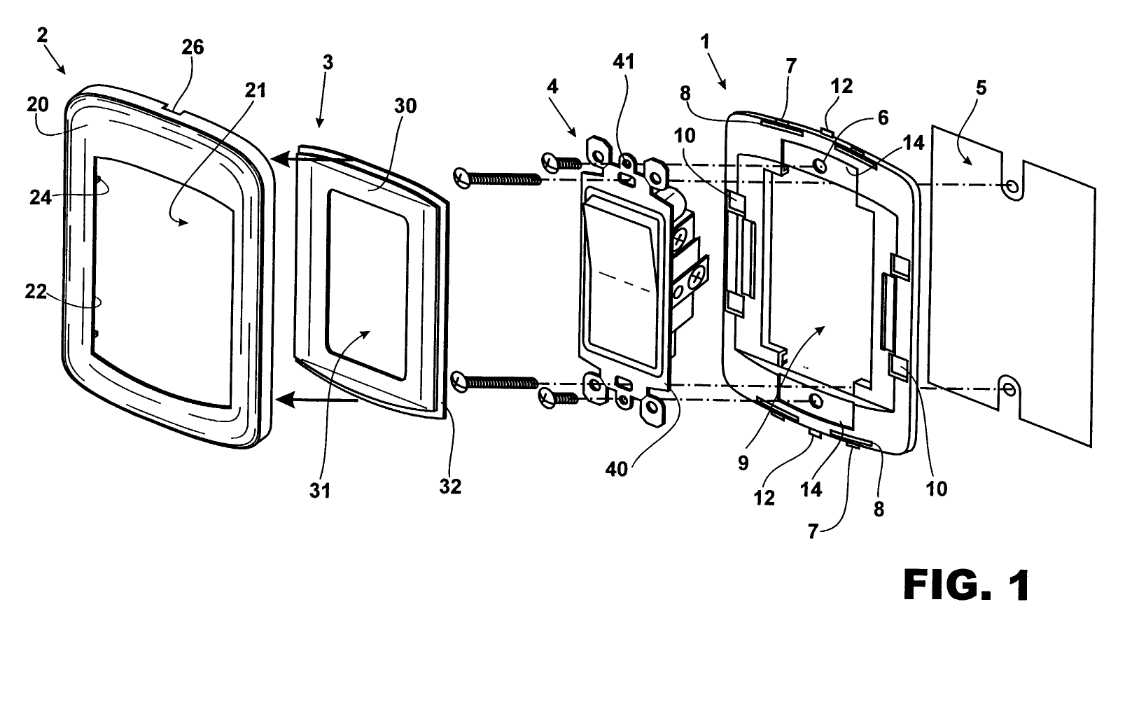

Referring now to the drawings and particularly to FIG. 1, the present invention consists of a set of cover 2 and support 1 for electric devices 4, comprising an intermediate support 1 on which the frame 40 of the electric device 4 is mounted-, and a decorative outer cover 2 with an inner frame 3, both mountable on the previously mentioned intermediate support 1.

As shown in FIG. 3, the intermediate support 1 is a piece of plastic material on which the electric device 4 is mounted by means of screws. In its head ends there are cavities 14 wherein the ends of the frame 40 are inserted. The central opening 9 allows to leave the electric device 4 exposed.

In addition, in the head ends of the intermediate support 1 there are elastic engagement means 7 consisting of elastically lessening teeth, below which there are the corresponding openings with elastic backward motion 8. Also, in the head ends there are supporting projections 12 for the dismount or disassembly between the intermediate support 1 and the decorative outer cover 2. As shown in FIG. 4, the back part of the intermediate support 1 has some interwoven structural reinforcements 13 that have been used to save material.

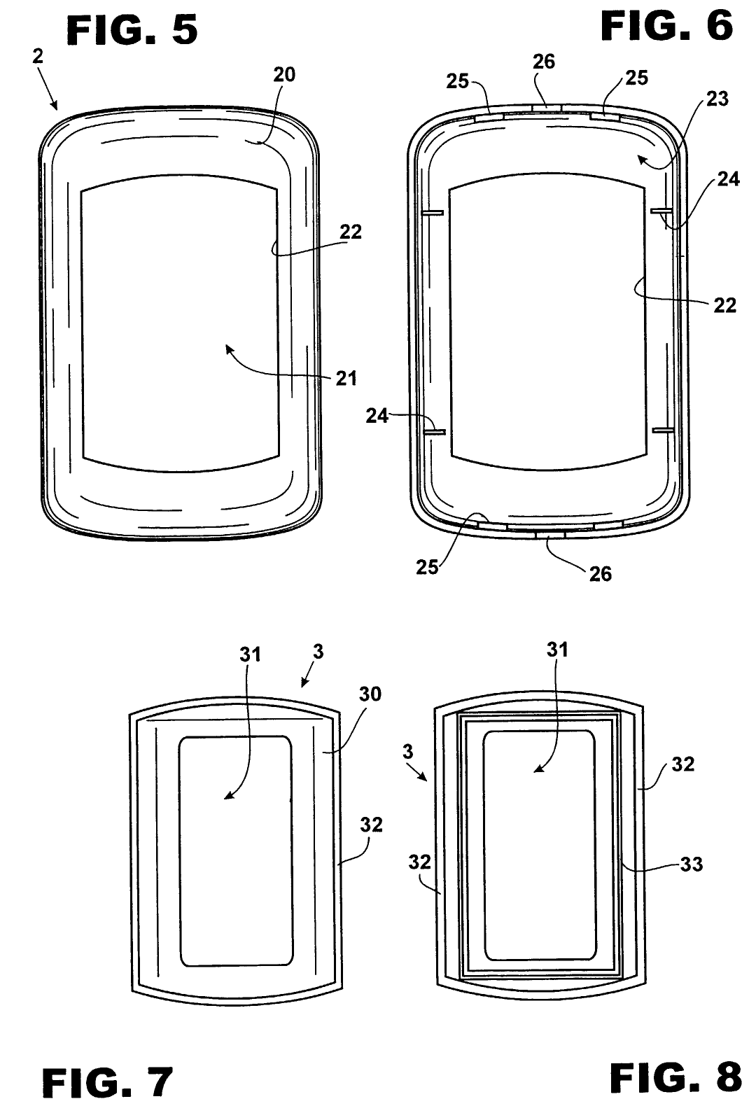

As shown in FIG. 5, the decorative outer cover 2 that can be also of plastic material, has a decorative outer surface 20 with an opening 21 in the middle. Such central opening 21 is defined by edges 22 against which the decorative inner frame 3 is arranged.

FIG. 6 shows the back part of the outer cover 2, wherein there are lateral engagement means 24 that are used to hold the decorative inner frame 3. In the head ends there are some retentive engagement means 25 that exert their action against the elastic engagement means 7 of the intermediate support 1. There are also some dismounting slots 26 complementing the supports 12 provided by the previously mentioned intermediate support 1.

As shown in FIG. 7, the inner frame 3 has a central opening 31 surrounding the electric device 4. Such inner frame 3, that can be also of plastic material, has a decorative outer face 30 defined by a side projection 32 that is used as support against the edges 22 of the outer cover 2 and is therefore held by the lateral engagement means 24.

Additional Embodiments

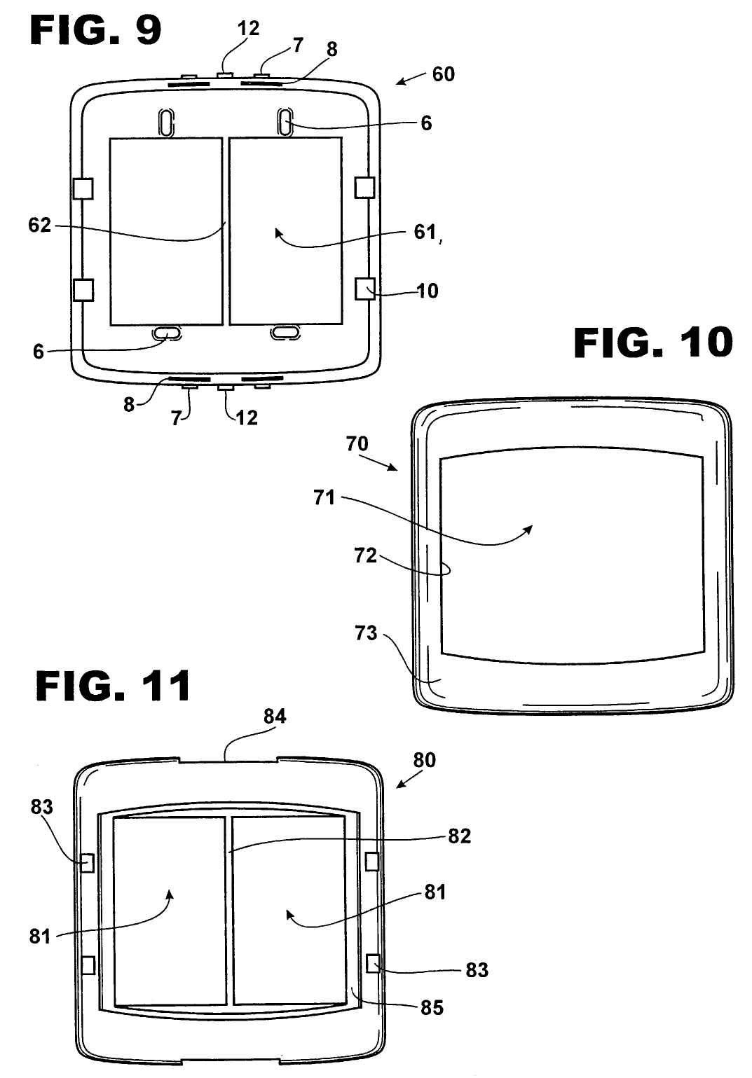

Another exemplary embodiment of the present invention consists of an assembly opening 5 that has two, three or more openings, as shown in FIGS. 9, 10 and 11.

FIG. 9 shows the intermediate support 60 wherein the intermediate partitioning element 62 defines two central openings 61 intended for both electric devices 4.

FIG. 11 shows that the decorative inner frame 80 extends over, occupying the whole cavity defined on the back part of the double decorative outer cover 70. In the head ends, there are passages 84 that allow the connection between the engagement means 7 of the intermediate support 60 and those of the decorative outer cover 70.

Although the exemplary embodiment of the present invention illustrates a double set, its construction principles are similar for sets with three or more openings.

Operation

As shown in FIG. 1, the frame 40 of the electric device 4 is mounted on the intermediate support 1 by means of screws. As the intermediate support 1 is bigger than the assembly opening 5, it rests against the wall surrounding such assembly opening 5. The cavities 14 allow leveling the frame 40 in relation to the intermediate support 1.

Also, as shown in FIG. 1 the decorative inner frame 3 is engaged in the decorative outer cover 2 because its side projections 32 are retained by the lateral engagement means 24 of the above mentioned outer cover 2. This is shown in more detail in FIGS. 6, 7 and 8.

FIGS. 3 and 6 show that the retentive engagement means 25 of the decorative outer cover 2 allow the engagement in the elastic engagement means 7 of the intermediate support 1.

FIG. 3 shows that the intermediate support 1 has side cavities 10 that house the lateral engagement means 24 shown in FIG. 6.

The presence of a slot 26 and a dismount point 12 is used to introduce a screwdriver or similar instrument that exerts pressure to release the engagement between the decorative outer cover 2 and the intermediate support 1.

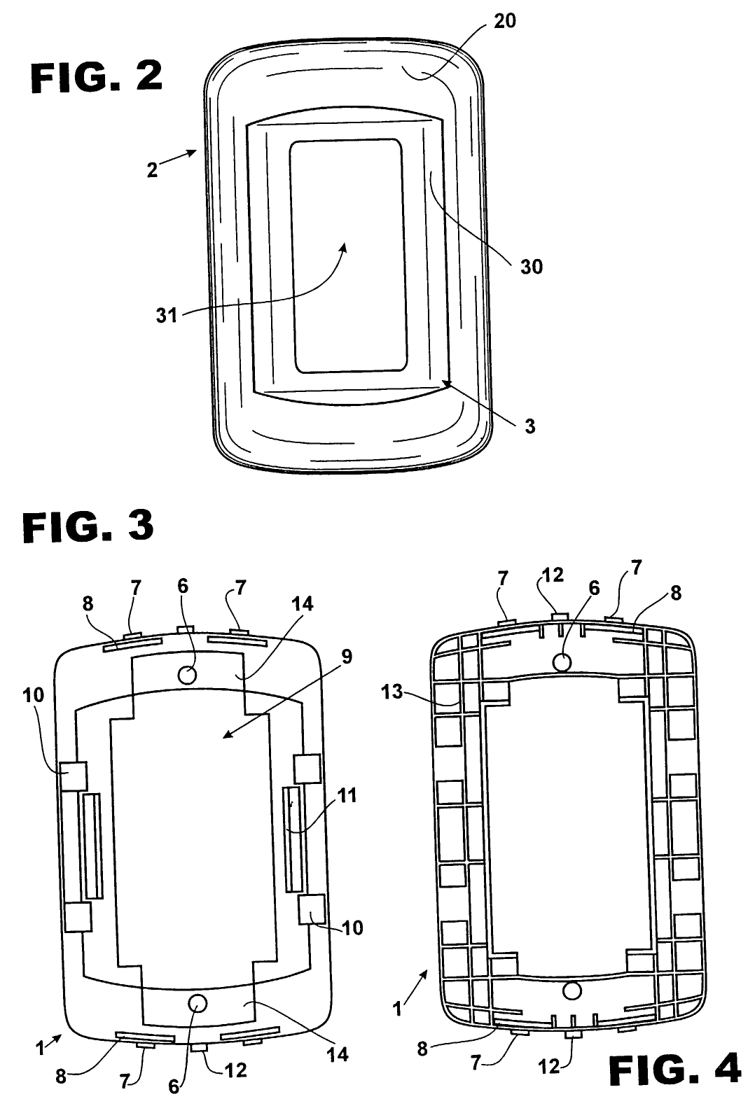

FIG. 2 shows what the set looks like when assembled. The fact of having outer covers 2-70 and inner frames 3-80 with different outer surfaces 20-73 and 30-85 allow to exchange them freely since they can be easily dismounted.

There is no doubt that when the present invention is put into practice further modifications may be introduced with regard to certain details related to the shape and the manner in which it is constructed. However, this does not imply a deviation from the fundamental principles that are clearly set forth in the appended claims.

We claim:

1) a set of cover and support for electric devices such as an electric switch or power socket mounted on an assembly opening, comprising:
an intermediate support that extends over such assembly opening; such intermediate support, on which the frame of such electric device is mounted, having a central opening for such electric device and retentive engagement means in, at least, two of its opposite side edges;
a decorative outer cover whose central opening is bigger than the electric device and having retentive engagement means in two of its opposite side edges, in correspondence with such intermediate support;
A removable decorative inner frame that, when mounted on such outer cover, surrounds the electric device; and
Retentive engagement means between the outer cover and such inner frame.

2) A set of cover and support for electric devices according to claim 1, wherein the intermediate support creates cavities in the supporting areas of the electric device frame, in such a way that such cavities determine a hollow arrangement of such frame with respect to such intermediate support.

3) A set of cover and support for electric devices according to claim 1, comprising: retentive engagement means between the outer cover and the inner frame, on the one hand; and the outer cover and the intermediate support, on the other.

4) A set of cover and support for electric devices according to claim 1, wherein the retentive engagement means consist of elastically lessening teeth and fitting grooves for such teeth.

5) A set of cover and support for electric devices according to claim 1, wherein the intermediate support and outer cover form a slot and dismount point.

6) A set of cover and support for electric devices according to claim 1, wherein the decorative inner frame extends farther, occupying the whole inner cavity of the decorative outer cover.

7) A set of cover and support for electric devices according to claim 1, including an intermediate support with a double central opening for two electric devices.

8) A set of cover and support for electric devices according to claim 1, including an intermediate support with two adjacent central openings that, while intended for both electric devices, are separated by an intermediate partitioning element.

9) A set of cover and support for electric devices according to claim 1, wherein the decorative inner frame has an intermediate partitioning element that defines two central openings for both electric devices.

10) A set of cover and support for electric devices according to claim 1 wherein the intermediate support is made of plastic material.

11) A set of cover and support for electric devices according to claim 1, wherein the decorative outer cover is made of plastic material.

12) A set of cover and support for electric devices according to claim 1, wherein the decorative inner frame is made of plastic material.
